(19) United States
(12) Patent Application Publication
(10) Pub. No.: US 2023/0316670 A1
(43) Pub. Date: Oct. 5, 2023

(54) VOLUMETRIC IMMERSION SYSTEM & METHOD

(71) Applicant: Charles Leon CLAPSHAW, Bondi Beach (AU)

(72) Inventor: Charles Leon CLAPSHAW, Bondi Beach (AU)

(21) Appl. No.: 18/022,627

(22) PCT Filed: Aug. 23, 2021
(86) PCT No.: PCT/AU2021/050934

§ 371 Date: Feb. 22, 2023

(30) Foreign Application Priority Data
Aug. 26, 2020 (AU) 2020903053

(51) Int. Cl. G06T 19/00; G06F 3/0346

(52) U.S. Cl. CPC G06T 19/006; G06F 3/0346; G06T 19/003

(57) ABSTRACT

A system and method to deliver a volumetric immersive experience to a user (4) via a user's device such as a user's smart phone or similar device (30) where volumetric image data (10), created from a remote environment, is transmitted and received on a user's smart phone (30). The smart phone (30) uses a movement sensor, so that as the device (30) is moved between a first (FIG. 2A) and second (FIG. 3A) position, either a first display mode (FIG. 2B) or a second display mode (FIG. 3B) is displayed on the smart phone display (30). In the first display mode (FIG. 2B), the user typically sees a bubble (2) on their screen (32). The user (4) can then move and experience the effect of being teleported (FIG. 3A) to within the bubble (2) whereby they can pan about and feel immersed within the remote environment (41) from which the volumetric image was created.

### TECHNICAL FIELD

The present invention relates to a system and method for providing a volumetric immersive experience to a user, and in particular to such a system and method by which this may be enabled using a user's smart phone or similar device.

### BACKGROUND ART

Any reference herein to known prior art does not, unless the contrary indication appears, constitute an admission that such prior art is commonly known by those skilled in the art to which the invention relates, at the priority date of this application.

Omnidirectional cameras are known to be used for creating 360 degree images. These are known to be used in a variety of applications including the creation of games, including virtual reality (VR), augmented reality (AR) and mixed reality games.

Specialised devices, such as head-mounted displays, may be used to provide a person with a 3D immersive experience in such gaming applications.

Various attempts have been made in seeking to provide a user with a teleportation effect in augmented reality (AR) and virtual reality (VR) environments working with smart phone devices, including those described in U.S. Pat. Nos. 10,699,482, 10,403,044, US 2016/0133230, US 2018/0059902 and U.S. Pat. No. 8,963,916.

U.S. Pat. No. 10,699,482 discloses a system (see FIG. 4) for a virtual participant to view an object (109) at an event from a virtual viewpoint (105) in a venue. This system requires the simultaneous capturing of different images of the object (109) from a plurality of data collectors/cameras (103) which are positioned at different locations around the venue, and then correlating this image data in a processor of a server to process/correlate/calculate virtual pixel information (151) that would make up a virtual image corresponding to the virtual viewpoint (105) of the virtual participant. The data collectors/cameras (103) to capture the images may be smart phones of real participants at different locations in the venue who are attending the event. After this image data is heavily processed, a virtual participant can thus view the event/object (109) from any desired viewpoint/angle (105) without attending the venue.

U.S. Pat. No. 10,403,044 discloses a system (see FIG. 8) for a remote user (810) in a real world location to place a virtual graphic content image render (sandcastle 820) on their smart phone device and then transmit data representing this, via a server, to another user (805). User (805) can then view on their device, both the digital image (815) of the virtual object (sandcastle 820) and a digital image (830) of the real world environment in which remote user (810) is located. Alternatively this system may operate in reverse, so that the user (810) adds the virtual image (sandcastle 815) and transmits this to the device of the remote user (810) so that then the remote user (810) sees this as a virtual image (sandcastle 820) depicted on their device in same position in their real world environment.

US 2016/0133230 relates to a method (see FIG. 2c) for users to visualize a shared augmented reality event from different point of views ([0050]). The live views of the real-world location are captured, which include the geometry, positions and textures of real-world objects (see FIG. 2A-222, [0038]), by one or more onsite computing devices (A1, A2, . . . AN) and sent to the central server (110), where the data is processed and sent to the offsite devices (B1, B2, . . . BN) (see FIG. 2A-225, [0039]). The offsite devices (B1, B2, BN) then receive the data provided by the central server (110) and simulates a virtual representation of the real-world scene [0052]. The virtual representation allows users of offsite devices (B1, B2, BN) to view the real-world location at various/different points of view (see FIG. 2c, [0052]). Onsite and offsite devices can then create and revise AR content, in which any changes to the AR content will synchronously update the views of all participating devices that are viewing the location (see FIG. 2c, see FIG. 2a-230, 240, 255, [0048]).

US 2018/0059902 discloses a method for teleportation between two visual environments (see FIG. 6). When a user (605) clicks on a selected hyperlink menu item (620) in the form of a 2D GUI (615) on their smartphone (610), the software uses the information stored in in the teleportal associated with that menu item to display the AR graphics (625) on the user's device display screen. In this view, the AR graphics (625) provide an appropriate GUI which the user may select to return back to the 2D application (600). In addition, the user (505) may also interact with items (520) of a 2D GUI (515) on the smartphone (510), to display the immersive 3D virtual environment (525, see FIG. 5).

U.S. Pat. No. 8,963,916 discloses a network (100) for producing and delivering (see FIGS. 1A, 1B, 1E) video and audio media streams (108, 109) to a user with a playback device (104), in which the video and audio of a production space (101) are captured ([col. 71. 33-35]) by lens arrays (106A, 106B) and microphones (107A-107D), respectively. The video media is then received by the content provider (103) which then maps the captured video to the hemispherical virtual display surfaces (134, 135) by using the rendering component (105, [col. 9,1. 35-40]). The mapped content (110) is then sent to the playback device (104), where it will display a viewable region of the virtual display surfaces, known as the virtual viewpoint (137), based on the orientation and position of the imaginary position (136) that is controllable by the user ([col. 10,1. 54-58]) of the playback device (104). Further, the network (100) can also provide additional media streams (111) to the content provider (103), to be rendered as AR objects ([col. 14,1. 46-48]) that are embedded into the virtual display space (138), and overlay the virtual display surfaces (134, 135).

### SUMMARY DISCLOSURE

The present invention seeks to provide a volumetric immersive experience to a user which does not require the use of a specialised device, such as a head-mounted display.

The present invention also seeks to provide a system and method for transmitting data in the form of an SMS or email or the like to facilitate the provision of volumetric immersive experience to a user positioned remotely.

The present invention also seeks to provide a system and method which, in one form, facilitates a user selectively experiencing two modes of experience.

In a broad form, the present invention relates to a system adapted to provide a volumetric immersive experience to a user, the system including: an image creation device, configured to create a volumetric image of a remote environment and generate a volumetric image data therefrom; a communications channel, configured to transmit said volumetric image data to a remote location; and, a user device, including a processor, a display, and a movement sensor, said user device being configured to: receive said transmitted volumetric image data; sense, via said movement sensor, relative movement of said user device by said user between a first position and a second position; process said received volumetric image data, to produce a first display mode image and a second display mode image; and, display either: a first display mode image, when said device is sensed to be in said first position; or, a second display mode image, when said device is sensed to be in a second position, wherein said user experiences an effect of being teleported to and being volumetrically immersed within the remote environment from which the volumetric image was created.

Preferably, said user device includes a smart phone or similar device which includes a camera, and wherein, in said first display mode, said user views an exterior view of said volumetric image superimposed over a real-time image being captured by said camera of said user device.

Preferably, to select between said first display mode and said second display mode, said user moves said user device in any direction as detected by said movement sensor, including any one or combination of forwards, backwards, left, right, up and down.

Preferably, in said second display mode, as said user horizontally and/or vertically moves and/or rotates said device, the respective portion of said created remote environment image is displayed on said display, such that said user experiences the teleportation effect of being immersed within and looking about in a corresponding horizontal and/or vertical direction and/or turning around within the remote environment from which the created image was created.

Preferably, said image creation device includes any one or combination of: a 3D or 360° camera; and, a 2D camera adapted to be moved to capture an image surrounding the camera.

Preferably, said volumetric image creation device includes a processor to map the captured image to the surface of a bubble or sphere or other 3D shape, and, said volumetric image data is generated therefrom.

Preferably, said communications channel includes any one or combination of: a wireless communications channel, including a 3G, 4G or 5G network channel; a Wi-Fi channel; a Bluetooth channel; and, a hardwired communications channel.

Preferably, a plurality of volumetric image data packets, each data packet corresponding to a respective created image are received by said user device such that said user may selectively display each image.

Preferably, said user device is an IOS device or an Android device, and wherein said image data is transmitted as any one or combination of: a USDZ file; a glTF file; an OBJ file; an FBX file; a DWG file; and a DXF file.

Preferably, said image data includes any one or combination of: a still image in the form of a 3D photo; and, a moving image in the form of a 3D video.

Preferably, said image data is transmitted in the form of any one or combination of: an SMS message; an email; and, a native viewing format.

Preferably, said created image which is generated, transmitted and received is saved in one or more memory device(s).

Preferably, said created image which is generated, transmitted and received is viewed by said user substantially in real time.

Preferably, in association with said image data, audio data is also generated, transmitted and received within said system.

Preferably, said volumetric image data is created from a real environment for any one or combination of: tourism; education; healthcare; marketing; research; entertainment; finance; industrial; and, e-commerce.

In a further broad form, the present invention relates to a user device adapted to deliver a volumetric immersive experience to a user, the device including a processor, a display, and, a movement sensor, said user device being configured to: receive a volumetric image data created from a volumetric image of a remote environment; sense, via said movement sensor, relative movement of said device by said user between a first position and a second position; process said received volumetric image data to produce a first display mode image and a second display mode image; and, display either: a first display mode image, when said device is sensed to be in said first position; or, a second display mode image, when said device is sensed to be in said second position, wherein said user experiences an effect of being teleported to and being volumetrically immersed within the remote environment from which the volumetric image was created.

Preferably, said device includes a smart phone or similar device which includes a camera, and wherein, in said first display mode, said user views an exterior view of said volumetric image superimposed over a real-time image being captured by said camera of said user device.

Preferably, to select between said first display mode and said second display mode, said user moves said user device in any direction as detected by said movement sensor, including any one or combination of forwards, backwards, left, right, up and down.

Preferably, in said second display mode, as said user horizontally and/or vertically moves and/or rotates said device, the respective portion of said created remote environment image is displayed on said display, such that said user experiences the teleportation effect of being immersed within and looking about in a corresponding horizontal and/or vertical direction and/or turning around within the remote environment from which the created image was created.

Preferably, a plurality of volumetric image data packets are received by said device, each data packet corresponding to a respective created image, such that said user may selectively display each image.

Preferably, said user device is an IOS device or an Android device, and wherein said image data is received by said user device as any one or combination of: a USDZ file; a glTF file; an OBJ file; an FBX file; a DWG file; and a DXF file.

Preferably, said image data includes any one or combination of: a still image in the form of a 3D photo; and, a moving image in the form of a 3D video.

Preferably, said image data is received by said device in the form of any one or combination of: an SMS message; an email; and, a native viewing format.

Preferably, said received created image is saved in one or more memory device(s).

Preferably, said created image which is generated, transmitted and received is viewed by said user substantially in real time.

Preferably, said displayed volumetric image data is created from a real environment for any one or combination of: tourism; education; healthcare; marketing; research;

entertainment; finance; industrial; and, e-commerce.

In a further broad form, the present invention relates to a method of providing a volumetric immersive experience to a user, the method including the steps of: creating a volumetric image of a remote environment; generating volumetric image data representative of said created image; transmitting said volumetric image data to a remote location via a communications channel; receiving said transmitted volumetric image data on a user device; determining relative movement of said user device by said user; processing said received volumetric image data to produce a first display image and a second display image; and, displaying either: said first display mode image, when said device is sensed to be in said first position; or, said second display mode image, when said device is sensed to be in said second position, wherein said user experiences an effect of being teleported to and being volumetrically immersed within the remote environment from which the volumetric image was created.

Preferably, in said first display mode, said user views an exterior view of said volumetric image superimposed over a substantially real-time image being captured by said camera of said user device.

Preferably, said user may alternate between said first display mode and said second display mode by said user moving said user device in any direction as detected by said movement sensor, including any one or combination of backwards, forwards, left, right, up and down.

Preferably, in said second display mode step, as said user horizontally and/or vertically moves and/or rotates said device, the respective portion of said created remote environment image is displayed on said display, such that said user experiences the teleportation effect of being immersed within and looking about in a corresponding horizontal and/or vertical direction and/or turning around within the remote environment from which the created image was created.

Preferably, in said creating step, said image is captured using any one or combination of: a 3D or 360° camera; and, a 2D camera adapted to be moved to capture an image surrounding the camera.

Preferably, in said image generating step, a processor maps the captured image to the surface of a bubble or sphere or other 3D shape, and, said volumetric image data is generated therefrom.

Preferably, in said transmitting step, said volumetric image data is transmitted via a communications channel which includes any one or combination of: a wireless communications channel, including a 3G, 4G or 5G network channel; a Wi-Fi channel; a Bluetooth channel; and, a hardwired communications channel.

Preferably, in said transmitting step, a plurality of volumetric image data packets are transmitted, each data packet corresponding to a respective created image are received by said user device such that said user may selectively display each image.

Preferably, in said transmitting step, said image data is transmitted as any one or combination of: a USDZ file; a glTF file; an OBJ file; an FBX file; a DWG file; and a DXF file.

Preferably, in said capturing step, said image data is captured to include any one or combination of: a still image in the form of a 3D photo; and, a moving image in the form of a 3D video.

Preferably, in said transmitting step, said image data is transmitted in the form of any one or combination of: an SMS message; an email; and, a native viewing format.

Preferably, said created image which is generated, transmitted and received is saved in one or more memory device(s).

Preferably, said created image which is generated, transmitted and received is viewed by said user substantially in real time.

Preferably, in association with said image data, audio data is also generated, transmitted and received.

Preferably, said volumetric image data is created from a real environment for any one or combination of: tourism; education; healthcare; marketing; research; entertainment; finance; industrial; and, e-commerce.

In a further broad form, the present invention relates to a method for delivering a volumetric immersive experience to a user via a user device, including the steps of: receiving volumetric image data representative of a volumetric image of a remote environment; sensing any relative movement of said device via a movement sensor of said device; processing said volumetric image data to create a first display mode image and a second display mode image; and displaying either: a first display mode image, when said device is sensed to be in a first position; or, a second display mode image, when said device is sensed to be in a second position, wherein said user experiences an effect of being teleported to and being volumetrically immersed within the remote environment from which the volumetric image was created.

Preferably, in said first display mode, said user views an exterior view of said volumetric image superimposed over a substantially real-time image being captured by said camera of said user device.

Preferably, said user may alternate between said first display mode and said second display mode by said user moving said user device in any direction as detected by said movement sensor, including any one or combination of backwards, forwards, left, right, up and down.

Preferably, in said second display mode step, as said user horizontally and/or vertically moves and/or rotates said device, the respective portion of said created remote environment image is displayed on said display, such that said user experiences the teleportation effect of being immersed within and looking about in a corresponding horizontal and/or vertical direction and/or turning around within the remote environment from which the created image was created.

Preferably, in said creating step, said image is captured using any one or combination of: a 3D or 360° camera; and, a 2D camera adapted to be moved to capture an image surrounding the camera.

Preferably, in said image generating step, a processor maps the captured image to the surface of a bubble or sphere or other 3D shape, and, said volumetric image data is generated therefrom.

Preferably, in said transmitting step, said volumetric image data is transmitted via a communications channel which includes any one or combination of: a wireless communications channel, including a 3G, 4G or 5G network channel; a Wi-Fi channel; a Bluetooth channel; and, a hardwired communications channel.

Preferably, in said transmitting step, a plurality of volumetric image data packets are transmitted, each data packet corresponding to a respective created image are received by said user device such that said user may selectively display each image.

Preferably, in said transmitting step, said image data is transmitted as any one or combination of: a USDZ file; a glTF file; an OBJ file; an FBX file; a DWG file; and a DXF file.

Preferably, in said capturing step, said image data is captured to include any one or combination of: a still image in the form of a 3D photo; and, a moving image in the form of a 3D video.

Preferably, in said transmitting step, said image data is transmitted in the form of any one or combination of: an SMS message; an email; and, a native viewing format.

Preferably, said created image which is generated, transmitted and received is saved in one or more memory device(s).

Preferably, said created image which is generated, transmitted and received is viewed by said user substantially in real time.

Preferably, in association with said image data, audio data is also generated, transmitted and received.

Preferably, said volumetric image data is created from a real environment for any one or combination of: tourism; education; healthcare; marketing; research; entertainment; finance; industrial; and, e-commerce.

### BRIEF DESCRIPTION OF THE DRAWINGS

Notwithstanding any other forms which may fall within the scope of the method and apparatus set forth in the summary, specific embodiments of the method and apparatus will now be described by the way of example and with reference to the accompanying drawing in which:

FIG. 1 illustrates a schematic view of the overall volumetric immersive experience system;

FIG. 2 illustrates an exemplary embodiment of a first display mode of the immersion system/method of the invention, FIG. 2(a) showing a user using their device in this first display mode, and, FIG. 2(b) depicting an image viewed by the user on their device display in this first display mode;

FIG. 3 illustrates an exemplary embodiment of a second display mode of the immersion system/method of the invention, FIG. 3(a) showing a user using their device in this second display mode, and, FIG. 3(b) depicting an image viewed by the user on their device display in this second display mode;

FIG. 4 illustrates and exemplary embodiment of the main steps in the overall method of creating a user immersive experience;

FIG. 5 illustrates an exemplary embodiment of a system for creating a volumetric image in accordance with the present invention;

FIG. 6 illustrates an exemplary embodiment of steps in the method of creating the volumetric image in the image creation system shown in FIG. 5;

FIG. 7 illustrates exemplary screen shots which may be typically displayed to a user creating a volumetric image in accordance with the system and method shown in FIGS. 5 and 6;

FIG. 8 illustrates an exemplary embodiment of a system for transmitting a volumetric image in accordance with the present invention;

FIG. 9 illustrates an exemplary embodiment of steps in the method of transmitting the volumetric image in the transmission system shown in FIG. 8;

FIG. 10 illustrates an exemplary embodiment of a system for displaying a volumetric image in accordance with the present invention;

FIG. 11 illustrates an exemplary embodiment of the steps in the method of displaying the volumetric image in the system described in FIG. 10;

FIG. 12 illustrates exemplary screen shots which may be typically displayed to a user in displaying a volumetric image in accordance with the system and method shown in FIGS. 10 and 11; and,

FIG. 13 illustrates the mapping of the volumetric image data to the interior of the sphere, where the user may pan horizontally and vertically, as well rotate the phone, to view relative portions of the volumetric image data.

### DETAILED DESCRIPTION

Throughout this specification, like numerals will be used to identify like features, unless otherwise specified.

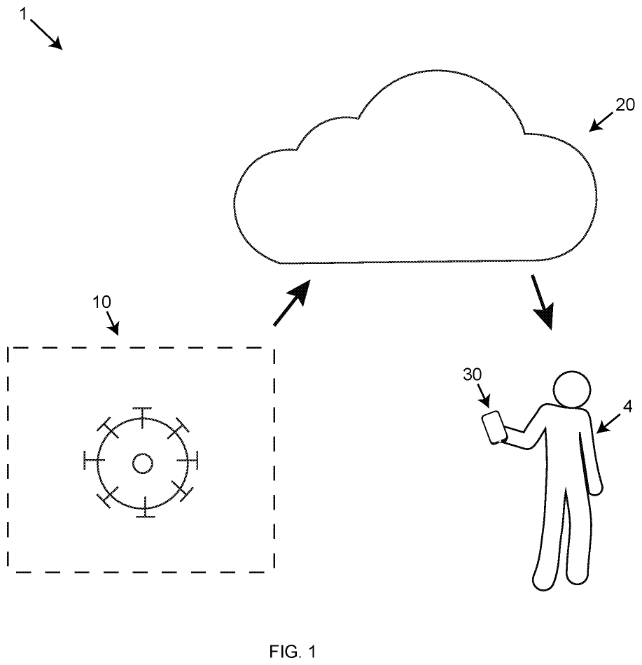

In FIG. 1, is shown a schematic overview of the system of the present invention which is adapted to provide an immersive volumetric experience to a user.

The system of creating, transmitting and receiving the volumetric immersive experience, generally designated by the numeral 1, includes an image creation device 10, a communications channel 20, and, a user device 30 held by a user 4.

The image creation device 10 is configured to capture or create a volumetric image 2 of a target scenery 5 and generate a volumetric image data 3, being a digital representation of the captured volumetric image.

The volumetric image 2 may be captured using any known omnidirectional or 3D camera and/or 2D camera adapted to be moved to capture an image surrounding the camera, commonly known as a panorama image.

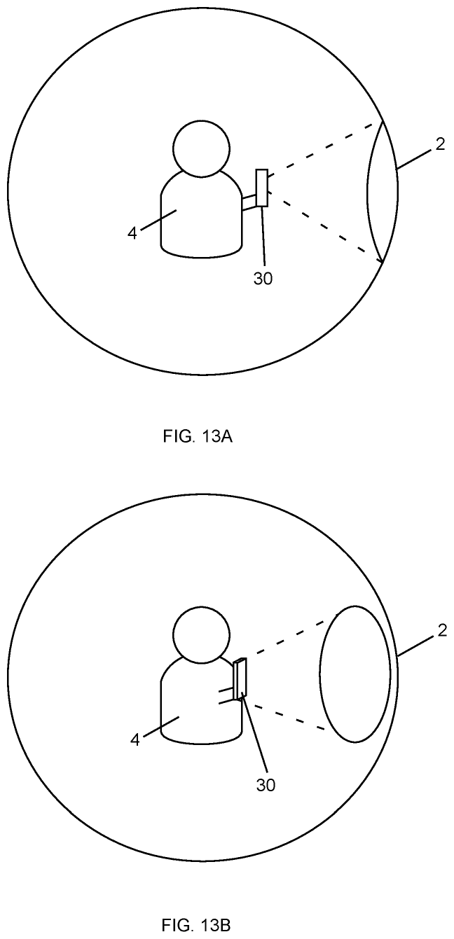

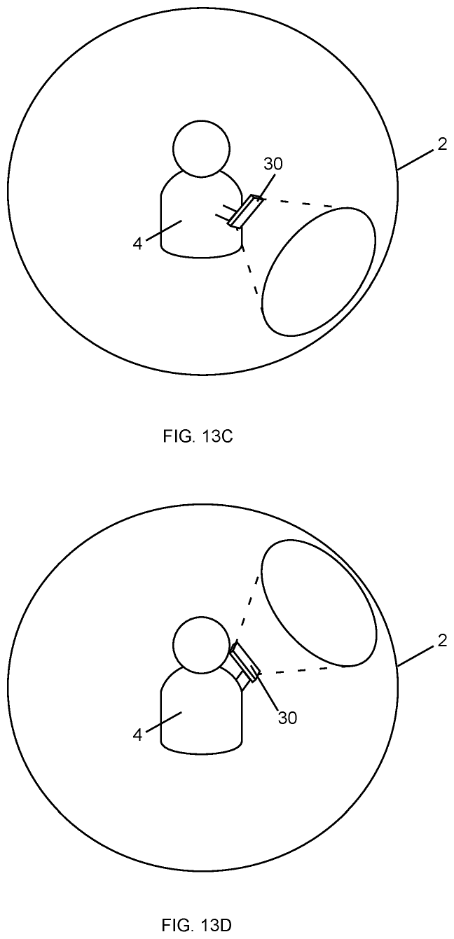

The image creation device 10 may include a processor to initially map the captured volumetric image 2 to the surface of sphere or ‘bubble’, or, to another 360° or 3D shape, such as depicted in FIG. 13, and, from which the volumetric image data 3 may then be generated.

The generated volumetric image data 3 may then be transmitted to a remote location via a communications channel 20. The communications channel 20 may include, but is not limited to, any wireless communications channel (a 3G, 4G or 5G network channel), a Wireless Fidelity channel (Wi-Fi), a Bluetooth channel, and/or a hardwired communications channel (Ethernet).

The user device 30 is typically a smartphone device, which incorporates amongst the other typical features of a smartphone, a processor 31, a display 32, a camera 36, and, a movement sensor 33.

The user device 30 is configured to receive the transmitted volumetric image data 3, determine relative movement of said user device 30 by the user 4, process the received volumetric image data 3, and, display a created volumetric, 3D or 360° image on a user device 30.

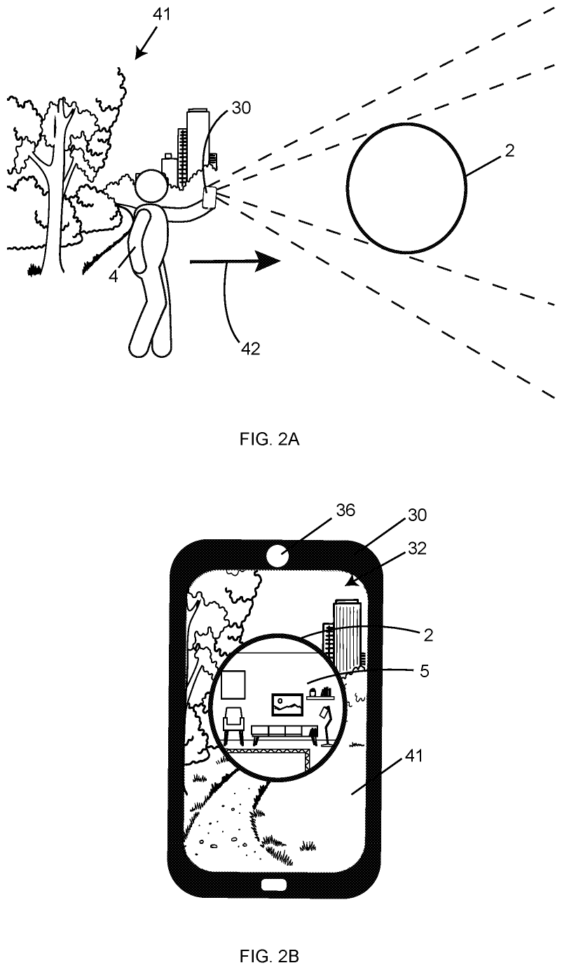

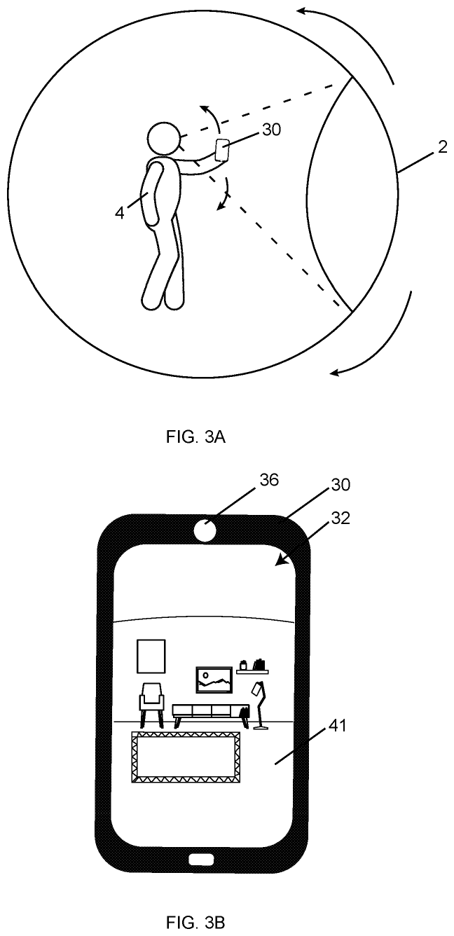

FIGS. 2 and 3 illustrate schematic views of the two display modes which are preferably displayed to a user to experience the volumetric immersive experience of the present invention in a preferred exemplary embodiment of the invention, the user may selectively move between these display modes as they choose.

In the example embodiment shown in FIGS. 2A and 2B, the user 4 is in an outdoor user environment 41 such as in a park with some trees and distant views of buildings in a cityscape, and holding a user smartphone device 30.

The user 4 then typically receives an SMS or email, which contains data pertaining to a volumetric image, on their user device 30.

The user 4 opens the message to display the ‘first display mode’ of this image on their device display 30, which appears to the user 4 as a spherical shape image or ‘bubble’ image 2, as depicted in FIGS. 2A and 2B.

The image 2 received on the display device 30, shown in FIG. 2B, is of a lounge or sitting room. This received image is displayed on the user device 30 in the form of a sphere or ‘bubble’ which overlays the image of the outdoor user environment in which the user is currently located.

The image of the outdoor environment 41 is captured by the camera of the user's device 30 substantially in real time, and is simultaneously displayed in the background on the display screen of the device 30, so as to create this effect to the user 4 that the ‘bubble’ 2 is floating within the real environment 41 of the user 4, such as depicted in FIG. 2B.

In this first viewing mode, if the user 4 stays in the same spot, but rotates the device 30, the background scene displayed on the user device 30 will correspondingly move, whilst the ‘bubble’ will appear to remain stationary, to add to the illusion that the bubble is ‘floating’.

That is, if the user 4 rotates the device 30 to the left, right, up and/or down, the background scene displayed on the device, and as captured in real time by the camera 36 of the user's device 30, will correspondingly move left, right, up and/or down, respectively.

In this first viewing mode, the user effectively views an ‘exterior’ view of the created volumetric, 3D or 360° image in the form of a ‘bubble’.

To transition from this first viewing mode to a second viewing mode, the user 4 moves, as indicated by arrow 42 in FIG. 2A.

In this second viewing mode, the user experiences the illusion of being teleported to within the ‘bubble’ 2, as depicted in FIGS. 3A and 3B. That is, the user 4 feels as if they are totally volumetrically immersed within the inside of the bubble 2.

The user 4, in this second viewing mode, no longer sees the image of their background real environment 41 displayed on the display of their user device 30, but only the received volumetric image.

The user 4 therefore feels like he or she is placed within the scene of the environment where the original volumetric image was captured.

In this second viewing mode, the user 4 may rotate the device 30, to view all around the interior of the ‘bubble’, that is, to see a 360-degree view within the ‘bubble’ environment.

That is, in this second viewing mode, the user 4 may horizontally and/or vertically move and/or rotate the device 30, so as to see a respective portion of the created volumetric, 3D or 360° image displayed on the display 32 of their smartphone device, such that the user 4 experiences a teleportation effect of being immersed within and being able to look around in a corresponding horizontal and/or vertical direction and/or turning around within the environment from which the original volumetric, 3D or 360° image was created.

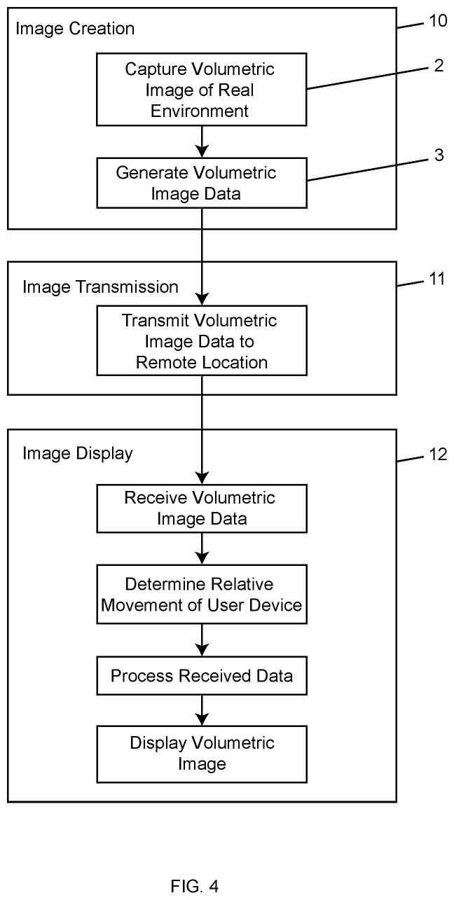

A general overview of the processes performed by the system described in FIGS. 1 to 3 is shown in the flowchart shown in FIG. 4, which outlines the main steps in creating 10 the volumetric image data 3, in transmitting 11 the image data 3, and, in displaying 12 the volumetric image 2 and volumetric image data 3 on the user device 30.

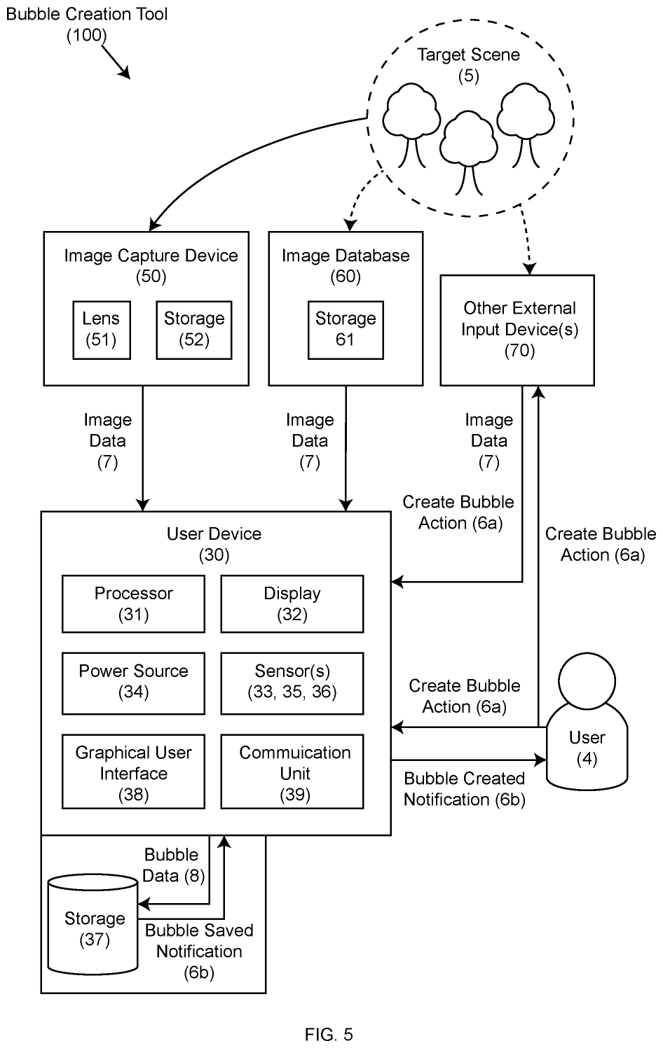

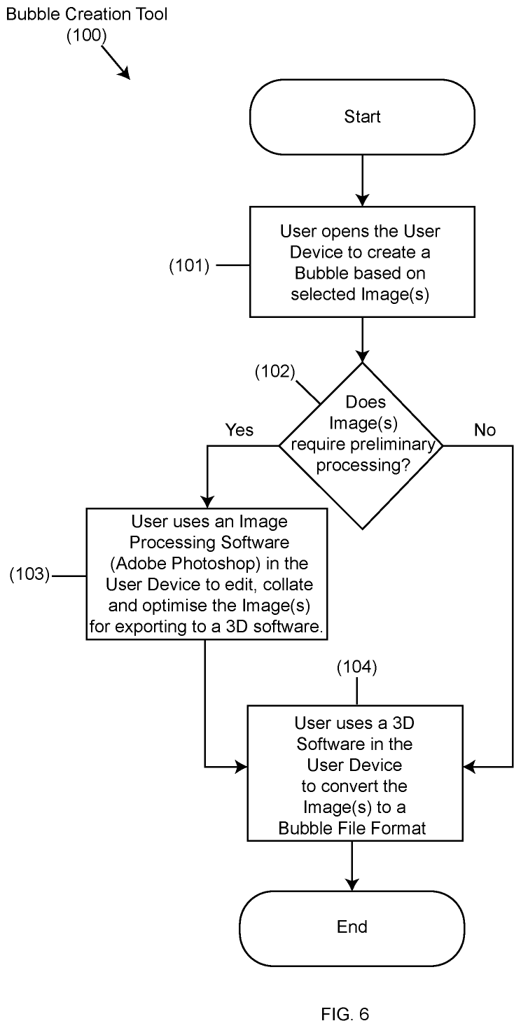

A more detailed system diagram of a specific exemplary embodiment of the bubble creation tool 100 will now be described with reference to FIG. 5, whilst an outline of these steps will be described with reference to FIG. 6.

The bubble creation tool 100 is a system and a method for creating the AR bubble data 8 (a variant of the volumetric image data 3), and is initiated (creation step 101) when the user 4 opens the user device 30 and actions to create an AR bubble data 8 based on one or more selected images, referred to hereinafter as an image data 7. After selecting the image data 7, the user 4 actions the user device 30, which can be performed either by the user device's sensor 35 (e.g. tapping the touchscreen or waving in front of the camera 36) or one or more external input devices 70 (e.g. clicking action via a mouse or pressing enter on the keyboard). The image data 7 can be acquired via several ways, including image capture device 50, image database 60, and the one or more external input devices 70.

The image capture device 50 comprises a lens 51 and a storage 52, which are adapted to capture image data 7 of a target scenery 5. The image capture device 50 then uploads this directly to a user device 30, or indirectly to an image database 60, where the user 4 may retrieve said image data 7 with his or her user device 30. Both the image database 60 and user device 30 each have a storage, 61 and 37, to store the image data 7.

Alternatively, the image data 7 may be generated by the one or more external input devices 70, which include but not limited to a mouse, keyboard, drawing tablet. Further, image data 7 may also be generated by the sensor(s) 35, which include but not limited to the user device's camera 36 and the user device's touchscreen. Similarly, image data 7 may be transferred directly to the user device 30 or indirectly to the image database 60.

Once the image data 7 has been received, creation step 102 occurs, where the user device 30 and user 4 determine whether the image data 7 meets the criteria for exporting to an AR bubble data 8. These requirements include but are not limited to the image data 7 being in the form of a single image, the image being panoramic, the single image having a file size of less than 15 MB, and the image having a JPEG file format. If these requirements are not met, the user 4 and user device 30, in particular a processor 31 of the user device 30, must perform a preliminary modification phase step 103 to edit, optimize, collate and/or reduce the image data 7 to an acceptable image data. The preliminary modification phase step 103 is generally performed with an image processing software such as Adobe Photoshop. Generally, step 103 would be traversed if the image data 7 is captured using the user device's camera 36.

If the requirements are met, or the image data 7 has now been processed into the acceptable image data, the user 4 and user device 30, in particular the user device's processor 31, performs a conversion phase step 104 to convert the image data 7 to an AR bubble data 8. The conversion phase step 104 is generally performed with a 3D sphere creation software. Once the AR bubble data 8 is created, the AR bubble data 5 is stored in the storage 37 of the user device 30, in which the user device 30 sends a notification 6b to the user 4 indicating that the AR bubble data 8 has been created and may be readily used, thus, concluding the bubble creation tool 100.

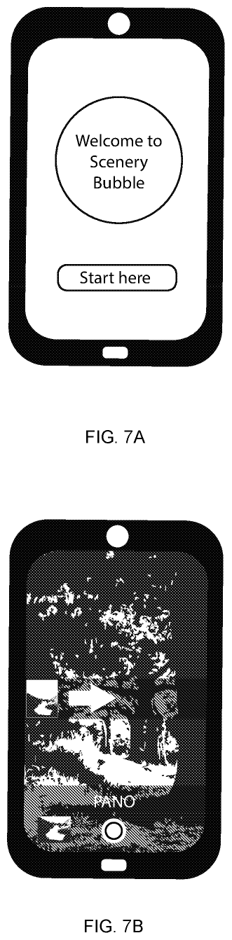

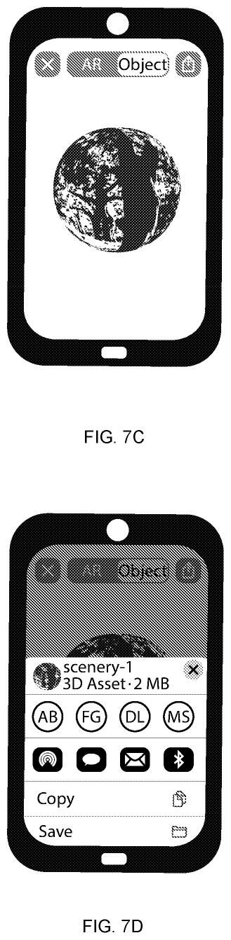

To assist in understanding of the system and method of the bubble creation process, some screenshots of typical user displays which may lead a user through the process are depicted in FIG. 7.

In this example, the volumetric, 3D or 360° image is created using a user smartphone device which is used to capture an image which surrounds the camera, by using a panorama feature available on certain smartphone devices. It should however be appreciated that the volumetric image may be captured using a 3D or 360° camera and associated software or by any alternative 2D camera and then utilising appropriate functions to effectively capture a volumetric, 3D or 360° image, or by using any combination of 2D and 3D camera functions.

In the system and method of the present invention, the volumetric image creation includes processing the captured volumetric image to effectively to map the captured image to the surface of a ‘bubble’ or sphere or other 3D shape, and, said volumetric image data is generated therefrom. Persons skilled in the art will appreciate that this may be achieved utilising a variety of methods.

Firstly, FIG. 7A is a screen view of the volumetric image creation device 10, where the user 4 is introduced and prompted to begin the application. Once the user 4 has begun the application on the user device 30, the application moves onto the next screen view, prompting the user 4 to take a panorama image 7 of the scenery 5, as shown in FIG. 7B. Once a panorama image 7 is taken, the application then moves onto the screen view shown in FIG. 7C, where the application has finished capturing the panorama image and has converted it into an AR bubble data 8, in which the AR bubble data 8 (volumetric image data 3) is shown as a volumetric image 2 for the user to view 6b. Finally, FIG. 7D shows that the user 4 may now distribute the volumetric image 2 as a volumetric image data 3, to other users with various sharing options shown (airdrop, SMS, email, Bluetooth etc.) using a communications unit 39.

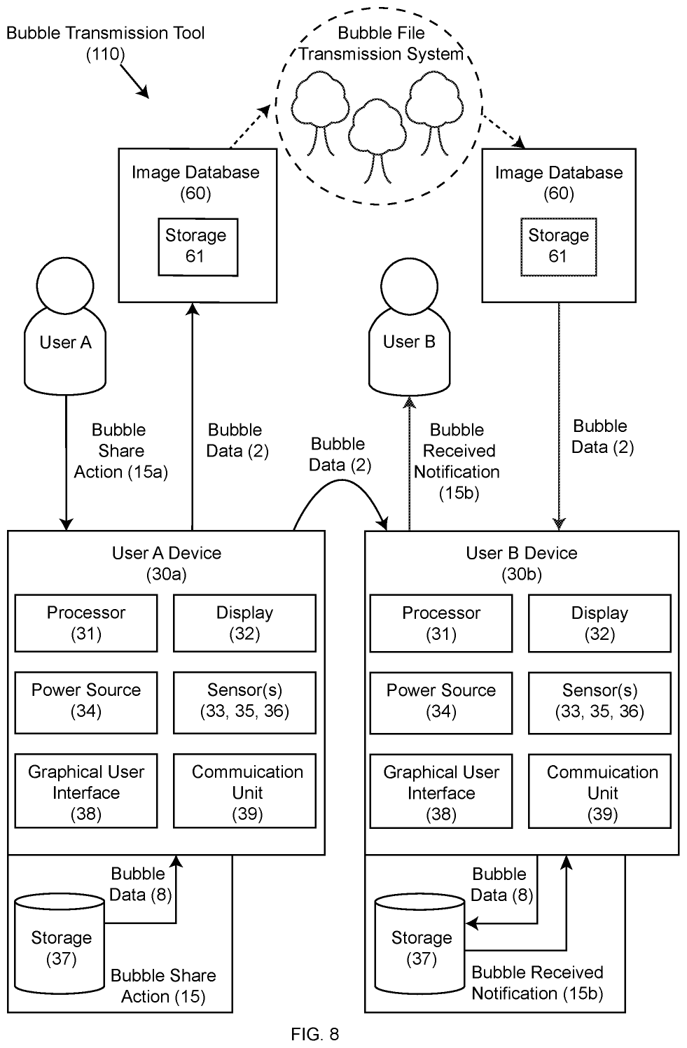

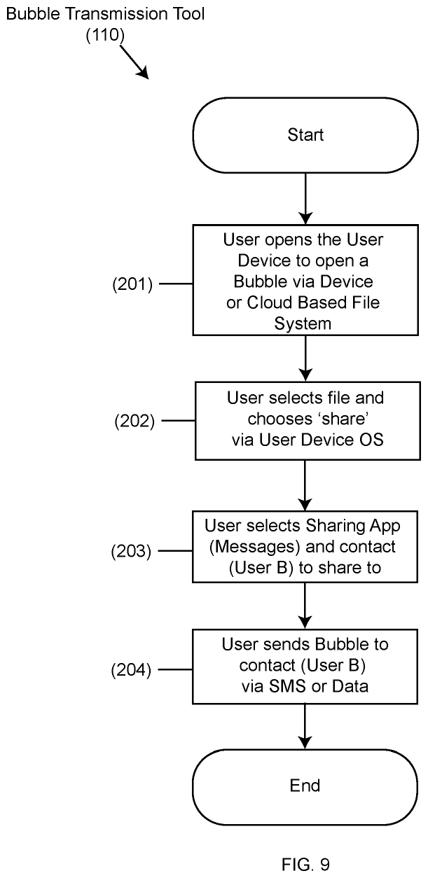

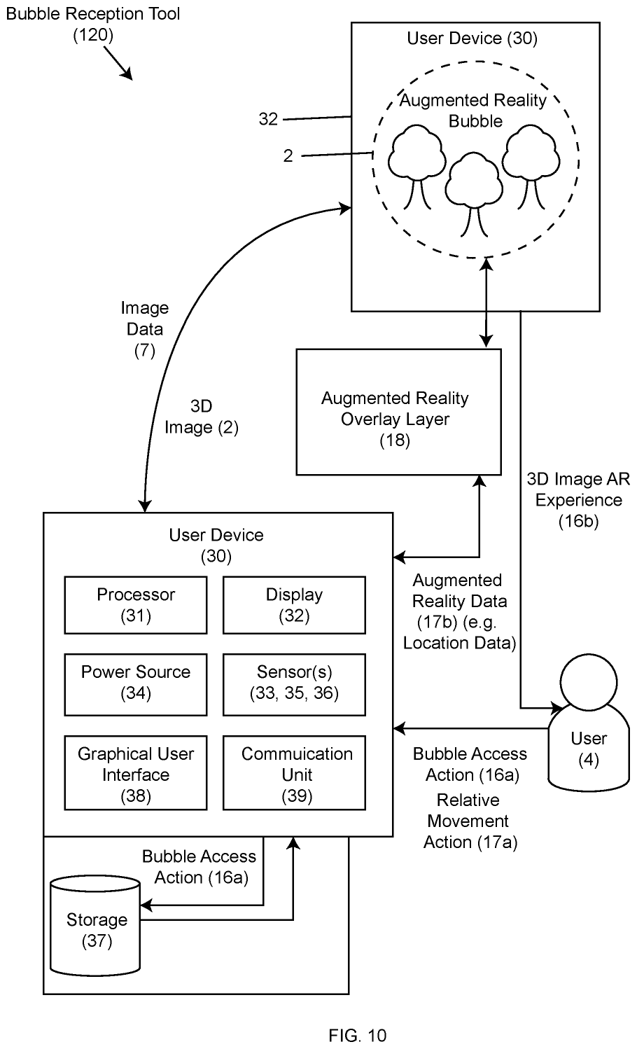

FIG. 8 shows an exemplary embodiment of a transmission system 110 for transmitting the volumetric image data 3 from a first User's smartphone device 30a to a second User's smartphone device 30b, whilst FIG. 9 outlines typical steps performed in implementation of the transmission process 11.

Although it is shown that there are two users in FIGS. 8 and 9, it should be understood that a user 4 can also be sharing the volumetric image data 3 from one user device to another user device, where the user 4 owns both of the user devices 30.

In this transmission process 110, any known communication may be utilised, including, but not limited to any one or combination of a wireless communications channel, including a 3G, 4G or 5G network channel, a Wi-Fi channel, a Bluetooth channel, and/or a hardwired communications channel. Such communications and the appropriate options which are usefully implemented in the present invention will be well understood to those skilled in the art.

The form of transmission of the volumetric image data 3 (in the particular form of the AR bubble data 8) and other appropriate data which may be usefully utilised in the display of the volumetric images 2 (in the particular form of the image data 7) may take a variety of known forms. The volumetric image data 3 may be described to be transmitted in the form of a data packet, which provides all the appropriate volumetric image data 3 and other usefully provided image information required to be transmitted and/or received by a user's device 30, including taking into consideration of the features and specification available on a particular user's smartphone device 30, and that different devices may incorporate different proprietary features with which the data pack may be required to interact.

It will also be appreciated that a plurality of images may be desired to be transmitted to a user 4, and that therefore a plurality of volumetric image data packets, each data packet corresponding to a respective created image 2 may be sent to and received by said user device 30 such that said user 4 may selectively display each created image 2.

In instances where a user device 30 is an IOS device or an Android device, the said volumetric image data 3 may typically be transmitted as any one or combination of a USDZ file, a glTF file, an OBJ file, an FBX file, a DWG file, a DXF file and/or any other similar or appropriate file, as will be appreciated by persons skilled in the art.

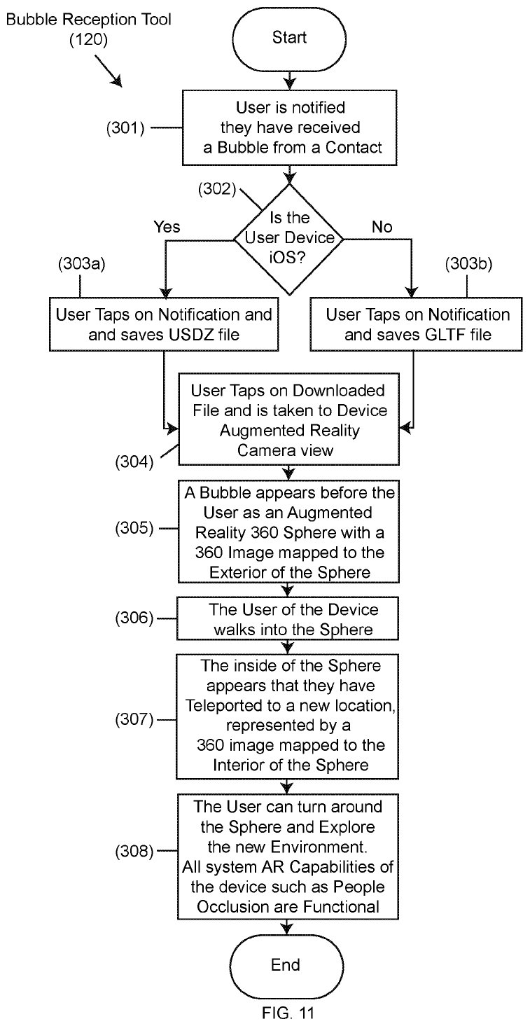

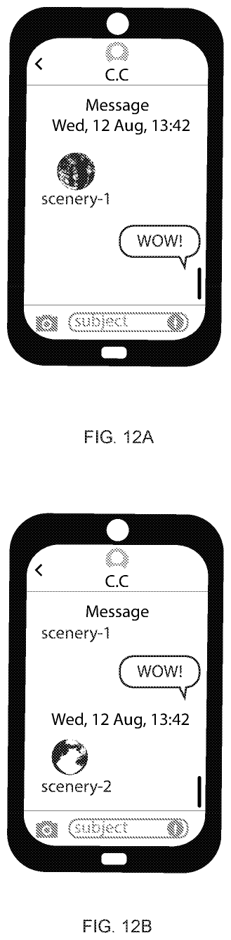

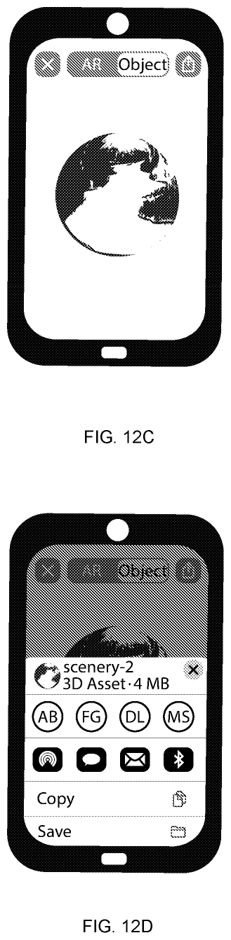

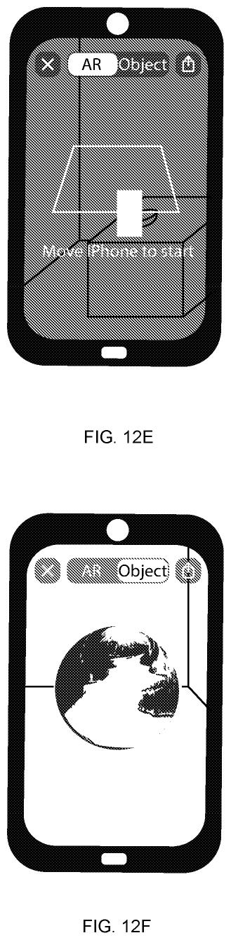

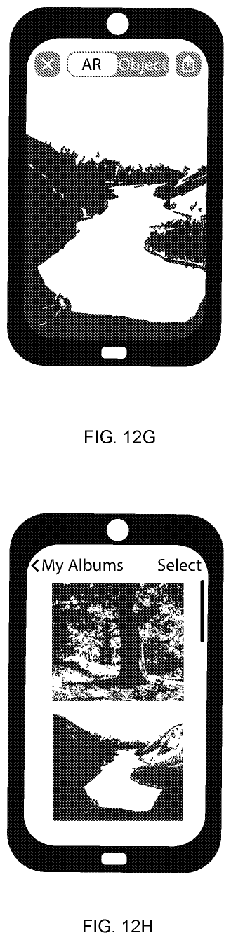

FIG. 10 shows an exemplary embodiment of the reception system 120 for receiving the volumetric image data 3 and thereafter displaying the created image 2 on a user smartphone device 30, whilst FIG. 11 outlines typical steps performed in this display process 12. The display process 12 and reception system 120 are further represented by the various display screens shown in FIG. 12, which may be typically displayed on a display screen 32 of a user's smartphone device 30 whilst displaying the created image 2 in the two display modes.

In the bubble reception tool 120, the user 4 sends a bubble action 16a to the user device 30, which retrieves the AR bubble data 8 from the storage 37. The user device 4 then converts this AR bubble data 8 to a volumetric image 2 and works in conjunction with the camera 36 capturing the image data 2, to create an augmented reality camera view, as shown in the example on the upper right of the same figure. The user device 30, then continuously monitors the location data of the user device 30, and the user 4 may change this location data 17b by moving the user device 30. The location data 17b will be determined by the AR overlay layer 18 whether the 3D sphere will be present in the AR camera view, and whether the image should display a first or second camera view. The display 32 of the user device 30 will show in real time the current status of the volumetric image AR experience 16b to the user 4. A more detailed method of this bubble reception tool 120 will be described hereinafter.

In FIG. 11, initial step 301 begins with the user 4 receiving the AR Bubble Data 8 (or volumetric Image Data 3). The user 4 may receive this bubble via SMS, as depicted in screen views of FIGS. 12a and 12b. The reception 120 system then analyses whether the user device 30 is an IOS, so as to provide the correct file format that is compatible with the user device 30, as shown in steps 302, 303a and 303b. After, step 304 occurs where the user 4 downloads the volumetric image data 3 and is taken to the user device's augmented reality camera view. To provide a clearer image, FIG. 12c is an example of step 304, where the user 4 has selected the second volumetric image data and is taken to the object mode view of the user device's augmented reality camera view. Within this augmented reality camera view, user 4 always has the option of sharing this volumetric image data 3 by clicking or touching the share button located at the upper right of the display 32, as shown in FIG. 12d.

Likewise, FIG. 12e may be accessed by the user 4 when the user 4 clicks or touches the AR button located at the upper centre left of the display 32. FIG. 12e will the shows a screen view of the user device 30 prompting the user 4 to find a flat and sufficient surface to place the volumetric image 2. When the user 4 has satisfied this criteria, step 305 occurs where the user 4 sees a 3D sphere at the placed location, as shown in FIG. 12f. This view is regarded as the first display mode of the volumetric image 2, where the image of the targeted scene 5 is mapped on the exterior of a sphere.

In steps 306 and 307, the user 4 walks to the location of sphere, in which the view of the display 32 transitions to a second display mode of the volumetric image 2 providing a surround view for the user to view the target scene with in a panoramic experience, as shown in the example of FIG. 12g. In this view, users 4 may rotate and turn to view different relative portions of the volumetric image data on their display 32, also known as step 308, as shown in the examples of FIGS. 13a to 13d.

Finally, users 4 may simply exit the second display mode by simply walking or otherwise moving out of the location of the sphere, in which the view would transition back to the first display mode of the volumetric image. The user 4 can always refer back to these volumetric images 2 by saving them into the photo album, as shown in FIG. 12h, which can be done by clicking or tapping the save function located within the sharing button.

It will be appreciated by persons skilled in the art that, whilst the examples hereinbefore described relate to the creation, transmission and viewing of a still image, that the invention may also be used to transmit a moving image or video image.

Furthermore, it will be appreciated that in other exemplary embodiments of the invention, these images may be transmitted and displayed in real time.

In other exemplary embodiments, a real-time moving image may therefore be captured, transmitted and displayed on a user device, also incorporating audible sounds, such that the user feels totally immersed in real time experience in the remote environment.

There are numerous applications for the invention. By way of example, an image in a restaurant may be captured, transmitted and displayed in real time to a remotely positioned user, such that the user may feel the experience of being immersed in the restaurant environment, with the ability to view images from different angles as if the user is located within the restaurant environment itself.

Similarly, other real time environments may be captured in real time, such as, but not limited to tourist destinations, classroom and other educational environments, a doctor's surgery or other healthcare environments, a bank or retail shop or other e-commerce environments, etc. Numerous other applications will become apparent from the aforementioned description.

Throughout this specification, the term ‘bubble’ has been used to describe the visual appearance of an image displayed to the user. It will be appreciated that this term is describing a visually new effect being displayed to the user, which is unknown in the prior art. In the use of this ‘bubble’ term, it should be understood that in the exemplary embodiments which have been described, in a first visual mode, the user typically sees a substantially 3D spherical shape which ‘floats’ in an overlaying manner over the real environment, whilst in a second visual mode, the user enters and is effectively teleported and immersed within the ‘bubble’. Furthermore, the user may transition between the two modes by moving the smartphone device. It should however be appreciated that the ‘bubble’ may not necessarily be limited to being of a spherical shape but could be any other substantially enclosed shape.

Also, throughout this specification, the term ‘volumetric’ has been used to describe the effect of a user being immersed within a space such as a sphere or other shaped object which has three dimensional (3D) shape. This may include shapes such as a sphere, hemisphere, cube, cylinder, cuboid, prism, tetrahedron, dodecahedron or any other 3D shape.

In the forgoing description of preferred embodiments, specific terminology has been resorted to for the sake of clarity. However, the invention is not intended to be limited to specific terms so selected, and it is to be understood that each specific term includes all technical equivalents which operate in a similar manner to accomplish a similar technical purpose. Terms such as “front” and “rear”, “forward” and “back”, “inner” and “outer”, “interior” and “exterior”, “above”, “below”, “upper” and “lower”, “up” and “down”, and the like, are used as words of convenience to provide reference points and are not to be construed as limiting terms.

In this specification the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, addition and/or changes can be made thereto without departing from the scope and spirit of the disclosed embodiments, the embodiments being illustrative and not restrictive.

Furthermore, invention(s) have been describe in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g. aspects of one embodiment may be combined with aspects of another embodiment to realise yet other embodiments. Further, each independent feature or component of any given assembly may constitute an additional embodiment.

1. A system adapted to provide a volumetric immersive experience to a user, the system including:
an image creation device, configured to create a volumetric image of a remote environment and generate a volumetric image data therefrom, the volumetric image comprising:
an exterior view, where said remote environment image is mapped onto the exterior surface of a 3D shape, preferably bubble-shaped; and
an interior view, where said remote environment image is mapped onto the interior surface of said 3D shape,
a communications channel, configured to transmit said volumetric image data to a remote location; and,
a user device, including a processor, a display, a camera, and a movement sensor, said user device being configured to:
receive said transmitted volumetric image data;
sense, via said movement sensor, relative movement of said user device by said user between a first position and a second position;
process said received volumetric image data, to produce a first display mode image, where said user views said exterior view of said volumetric image superimposed over a real-time image being captured by said camera of said user device, and a second display mode image, where said user views said interior view of said volumetric image; and,
display either:
said first display mode image, when said device is sensed to be in said first position; or,
said second display mode image, when said device is sensed to be in said second position, wherein said user experiences an effect of being teleported to and being volumetrically and panoramically immersed within
said remote environment from which the volumetric image was created.

2. (canceled)

3. The system as claimed in claim 1, wherein, to select between said first display mode and said second display mode, said user moves said user device in any direction as detected by said movement sensor, including any one or combination of forwards, backwards, left, right, up and down.

4. The system as claimed in claim 1, wherein, in said second display mode, as said user horizontally and/or vertically moves and/or rotates said device, the respective portion of said created remote environment image of said interior view of said volumetric image is displayed on said display, such that said user experiences the teleportation effect of being immersed within and looking about in a corresponding horizontal and/or vertical direction and/or turning around within the remote environment from which the created remote environment image was created.

5. The system as claimed in claim 1, wherein said image creation device includes any one or combination of:
a 3D or 360° camera; and,
a 2D camera adapted to be moved to capture an image surrounding the camera.

6. The system as claimed in claim 1, wherein said volumetric image creation device includes a processor to map the captured image to said interior and exterior surfaces of said 3D shape, and, said volumetric image data is generated therefrom, wherein said 3D shape could be in the form of either a bubble, sphere or other 3D shape.

7. The system as claimed in claim 1, wherein said communications channel includes any one or combination of:
a wireless communications channel, including a 3G, 4G or 5G network channel;
a Wi-Fi channel;
a Bluetooth channel; and,
a hardwired communications channel.

8. The system as claimed in claim 1, wherein a plurality of volumetric image data packets, each data packet corresponding to a respective created image are received by said user device such that said user may selectively display each image.

9. The system as claimed in claim 1, wherein said user device is an IOS device or an Android device, and wherein said volumetric image data is transmitted as any one or combination of:
a USDZ file;
a glTF file;
an OBJ file;
an FBX file;
a DWG file; and
a DXF file.

10. The system as claimed in claim 1, wherein said volumetric image data includes any one or combination of:
a still image in the form of a photo; and,
a moving image in the form of a video.

11. The system as claimed in claim 1, wherein said image data is transmitted in the form of any one or combination of:
an SMS message;
an email; and,
a native viewing format.

12. The system as claimed in claim 1, wherein said created image which is generated, transmitted and received is saved in one or more memory device(s).

13. The system as claimed in claim 1, wherein said created image which is generated, transmitted and received is viewed by said user substantially in real time.

14. The system as claimed in claim 1, wherein in association with said volumetric image data, audio data is also generated, transmitted and received within said system.

15. The system as claimed in claim 1, wherein said volumetric image data is created from a real environment for any one or combination of:
tourism;
education;
healthcare;
marketing;
research;
entertainment;
finance;
industrial; and,
e-commerce.

16. A user device adapted to deliver a volumetric immersive experience to a user, the user device including a processor, a display, a camera, and, a movement sensor, said user device being configured to:
receive a volumetric image data created from a volumetric image of a remote environment, the volumetric image comprising:
an exterior view, where said remote environment image is mapped onto the exterior surface of a 3D shape, preferably bubble-shaped; and
an interior view, where said remote environment image is mapped onto the interior surface of said 3D shape,
sense, via said movement sensor, relative movement of said device by said user between a first position and a second position;
process said received volumetric image data, to produce a first display mode image, where said user views said exterior view of said volumetric image superimposed over a real-time image being captured by said camera of said user device, and a second display mode image, where said user views said interior view of said volumetric image; and,
display either:
said first display mode image, when said device is sensed to be in said first position; or,
said second display mode image, when said device is sensed to be in said second position, wherein said user experiences an effect of being teleported to and being volumetrically and panoramically immersed within said remote environment from which the volumetric image was created.

17. (canceled)

18. The user device as claimed in claim 16, wherein, to select between said first display mode and said second display mode, said user moves said user device in any direction as detected by said movement sensor, including any one or combination of forwards, backwards, left, right, up and down; wherein preferably, in said second display mode, as said user horizontally and/or vertically moves and/or rotates said device, the respective portion of said created remote environment image of said interior view of said volumetric image is displayed on said display, such that said user experiences the teleportation effect of being immersed within and looking about in a corresponding horizontal and/or vertical direction and/or turning around within the remote environment from which the created remote environment image was created.

19. (canceled)

20. The user device as claimed in claim 16, wherein a plurality of volumetric image data packets are received by said device, each data packet corresponding to a respective created image, such that said user may selectively display each image; wherein preferably said user device is an IOS device or an Android device, and wherein said volumetric image data is received by said user device as any one or combination of:
a USDZ file;
a glTF file;
an OBJ file;
an FBX file;
a DWG file; and
a DXF file.

21. (canceled)

22. (canceled)

23. (canceled)

24. (canceled)

25. (canceled)

26. (canceled)

27. A method of providing a volumetric immersive experience to a user, the method including the steps of:
creating a volumetric image of a remote environment, the volumetric image comprising:
an exterior view, where said remote environment image is mapped onto the exterior surface of a 3D shape, preferably bubble-shaped; and
an interior view, where said remote environment image is mapped onto the interior surface of said 3D shape,
generating volumetric image data representative of said created volumetric image;
transmitting said volumetric image data to a remote location via a communications channel;
receiving said transmitted volumetric image data on a user device, the user device including a processor, a display, a camera, and a movement sensor;
determining relative movement of said user device by said user;
processing said received volumetric image data to produce a first display mode image, where said user views said exterior view of said volumetric image superimposed over a real-time image being captured by said camera of said user device, and a second display mode image, where said user views said interior view of said volumetric image; and,
displaying either:
said first display mode image, when said device is sensed to be in said first position; or,
said second display mode image, when said device is sensed to be in said second position, wherein said user experiences an effect of being teleported to and being volumetrically and panoramically immersed within said remote environment from which the volumetric image was created.

28. (canceled)

29. The method as claimed in claim 27, wherein said user may alternate between said first display mode and said second display mode by said user moving said user device in any direction as detected by said movement sensor, including any one or combination of backwards, forwards, left, right, up and down; wherein preferably, in said second display mode step, as said user horizontally and/or vertically moves and/or rotates said device, the respective portion of said created remote environment image of said interior view of said volumetric image is displayed on said display, such that said user experiences the teleportation effect of being immersed within and looking about in a corresponding horizontal and/or vertical direction and/or turning around within the remote environment from which the created remote environment image was created.

30. (canceled)

31. The method as claimed in claim 27, wherein, in said creating step, said image is captured using any one or combination of:
a 3D or 360° camera; and,
a 2D camera adapted to be moved to capture an image surrounding the camera, and,
wherein preferably, in said image generating step, a processor maps the captured image to said interior and exterior surfaces of said 3D shape, and, said volumetric image data is generated therefrom, wherein said 3D shape could be in the form of either a bubble, sphere or other 3D shape.

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)
